(19) United States
(12) Patent Application Publication
(10) Pub. No.: US 2012/0167129 A1
(43) Pub. Date: Jun. 28, 2012

(54) MULTIMEDIA CONTENT OUTPUT DEVICE AND METHOD FOR FILTRATING MULTIMEDIA CONTENT SIGNALS ACCORDING TO AUDIENCE AGE

(76) Inventors: Guan-De LIOU, Taipei City (TW); Stephen Tsai, Taipei County (TW); Shao-Yu Hwang, Taipei City (TW)

(21) Appl. No.: 13/083,302

(22) Filed: Apr. 8, 2011

(30) Foreign Application Priority Data
Dec. 24, 2010 (TW) 99145946

(51) Int. Cl. H04N 7/16

(52) U.S. Cl. 725/27; 725/25; 725/30

(57) ABSTRACT

A multimedia content output apparatus for filtrating multimedia content signals according to audience age includes an image capturing element, an age identifying module and a control circuit. The control circuit receives an image signal and a content-classification identifying message. The image capturing element captures an audience image for the age identifying module to analyze the audience image and obtain an age identification value according to the audience's age. The control circuit loads plural age identification value ranges, and preset content-classification codes corresponding to each of the age identification value ranges. Then the control circuit determines whether the content-classification identifying message matches with the preset content-classification code corresponding to the age identification value range. If matched, the control circuit transforms the image signal as a display driving signal and outputs to a display unit for displaying images.

### CROSS-REFERENCES TO RELATED APPLICATIONS

This non-provisional application claims priority under 35 U.S.C. §119(a) on Patent Application No. 99145946 filed in Taiwan, R.O.C. on Dec. 24, 2010, the entire contents of which are hereby incorporated by reference.

### BACKGROUND OF THE INVENTION

1. Field of Invention

The present invention relates to signal output of multimedia, and in particular, to a multimedia content output device and method for filtrating multimedia content signals according to audience age.

2. Related Art

A television is an application product that provides multimedia contents, and may be operated by any family members. However, various multimedia contents are suitable for different ages. Especially for children and teenagers, there are a lot of multimedia contents not appropriate for them to watch.

A conventional approach is to restrict children and teenagers from watching certain multimedia contents by parents' supervising. However such supervising cannot be always performed. Therefore in the conventional technology, some technical approaches regarding to restrict available multimedia contents on TV have been proposed.

The most common way is to block specific TV channels or multimedia contents, in which the television or display apparatus requires to input a preset password to display multimedia contents in order to view the contents. For example, R.O.C. patent TW399182 proposed a restriction control method for obscene/violence programs; the audience is required to input passwords so that certain channels or programs may be displayed.

In the meantime, the U.S. Government applies a V-CHIP program filtrating technology. Content-classification identifying messages must be sent along with the transmitted TV programs, so that the television apparatus may be able to identify the content classification. Since Jan. 1, 2000, all televisions above 13 inches must be equipped with V-CHIP technology, and many V-CHIP application solutions have been proposed.

For instance, U.S. Pat. No. 4,930,160 discloses an automatic censorship of video programs, in which the content-classification identifying message sent accompanying with the TV program is compared with a preset classification setting. If the sent content-classification identifying message matches the preset classification setting, the transmitted video programs will be shown; if the sent content-classification identifying message does not match the preset classification setting, a replaced image will be shown. Similar methods to display a replaced image are also disclosed in U.S. Pat. Nos. 5,583,576 and 6,519,770. In U.S. Pat. No. 5,583,576, a program list with other available channels is shown for the audience. In U.S. Pat. No. 6,519,770, a method of interfering the display image is proposed by distorting, diluting, mixing up the original image, replacing with blank image, or covering the original image with other pre-stored image or text message. The audio portion may be switched to mute or replaced the original audio output with a pre-recorded sound section.

In the V-CHIP technologies mentioned above (U.S. Pat. No. 4,930,160, U.S. Pat. No. 5,583,576, and U.S. Pat. No. 6,519,770) or the TW399182 patent, the way of deactivating the filtrating function is to manually input the password. However, such password could be obtained by children or teenagers, and causing the failure of the restriction control. Therefore, how to improve the restriction control and avoid young family members to access the restricted authority is still a critical technical issue.

### SUMMARY OF THE INVENTION

In the conventional technology, the method of using a password to deactivate the multimedia filtrating function is easy to have the problems of password leakage and control failure.

Accordingly, the present invention provides a multimedia content output device and method for filtrating multimedia content signals according to audience age, in which the multimedia contents are automatically filtrated according to audience age.

According to the present invention, a multimedia content output apparatus for filtrating multimedia content signals according to audience age includes an image capturing element, an age identifying module and a control circuit. The control circuit receives an image signal and a content-classification identifying message. The image capturing element captures an audience image for the age identifying module to analyze the audience image and obtain an age identification value according to the audience's age. The control circuit loads plural age identification value ranges, and preset content-classification codes corresponding to each of the age identification value ranges.

The control circuit determines whether the content-classification identifying message matches with the preset content-classification code corresponding to the age identification value range. If matched, the control circuit transforms the image signal as a display driving signal and outputs to a display unit for displaying images. On the other hand, if not match, the control circuit blocks the display driving signal.

According to the present invention, a multimedia content output method for filtrating a multimedia content signal according to an audience's age includes the followings, a multimedia content signal, wherein the multimedia content signal is decoded into an image signal and a content-classification identifying message. Capture an audience image of the audience. Analyze the audience image to obtain an age identification value corresponding to the audience's age. Load a program classification table, wherein the program classification table records multiple age identification value ranges and preset content-classification codes corresponding to the age identification value ranges. Determine whether the content-classification identifying message matches with any of the preset content-classification codes corresponding to the age identification value range. And transform the image signal as a display driving signal and output if the content-classification identifying message matches with any of the preset content-classification codes.

According to the present invention, the audience age is identified from the audience image, and then used as a base to filtrate the multimedia contents. Therefore, the parents no longer need to be present to supervise the children or teenagers while viewing the contents. Since the method needs not to preset or input password, the problem of password leakage may be prevented. Hence, according to the present invention, the failure problem of restriction control can be effectively avoided.

Preferred embodiments of the present invention and efficacies thereof will be illustrated in detail below with the accompanying drawings.

### BRIEF DESCRIPTION OF THE DRAWINGS

The present invention will become more fully understood from the detailed description given herein below for illustration only, and thus are not limitative of the present invention, and wherein:

FIG. 1 is a circuit block diagram of a multimedia content output apparatus according to a first embodiment of the present invention;

FIG. 2 is a schematic diagram of a program classification table according to the first embodiment of the present invention;

FIG. 3 is a flow chart of a multimedia content output method according to the first embodiment of the present invention;

FIG. 4 is another flow chart of the multimedia content output method according to the first embodiment of the present invention;

FIG. 5 is another flow chart of the multimedia content output method according to the first embodiment of the present invention;

FIG. 6 is a flow chart of a multimedia content output method according to a second embodiment of the present invention; and

FIG. 7 is a flow chart of a multimedia content output method according to a third embodiment of the present invention.

### DETAILED DESCRIPTION OF THE INVENTION

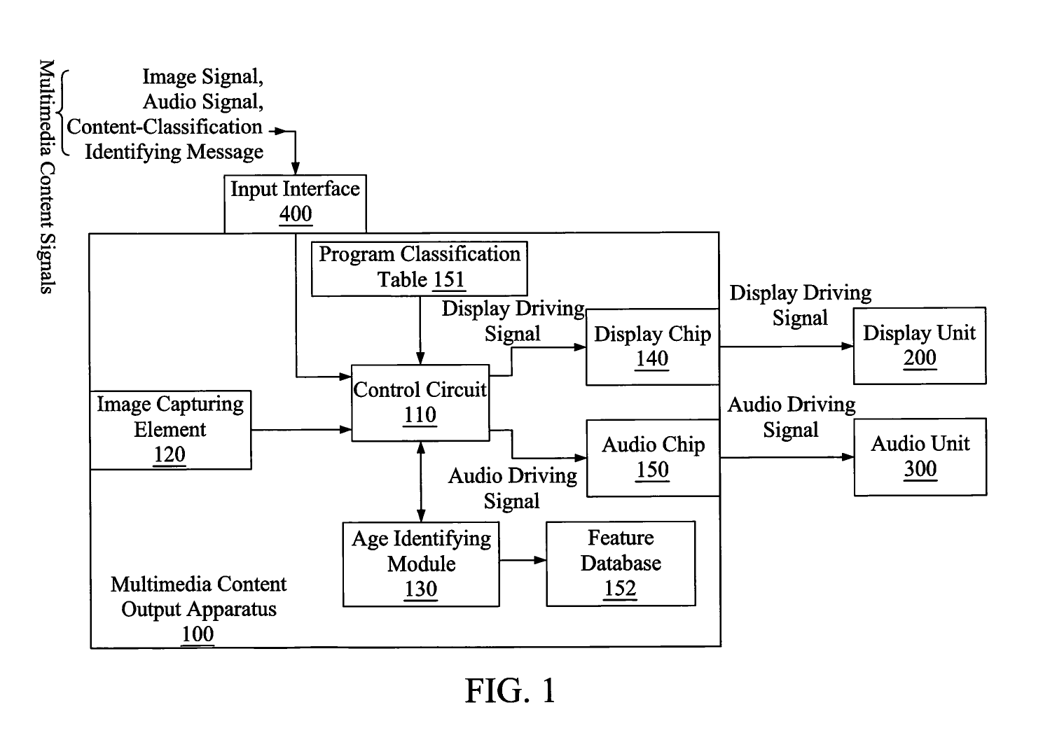

Refer to FIG. 1. According to a first embodiment of the present invention, a multimedia content output apparatus 100 disclosed for filtrating multimedia content signals according to audience age is adapted to receive a multimedia content signal. The multimedia content signal may at least be decoded as an image signal, an audio signal and a content-classification identifying message. According to the audience's age and the content-classification identifying message, the multimedia content output apparatus 100 determines whether to output the image signal and audio signal to drive a display unit 200 and an audio unit 300.

As shown in FIG. 1, the multimedia content output apparatus 100 includes a control circuit 110, an image capturing element 120, an age identifying module 130 and a display chip 140.

As shown in FIG. 1, the control circuit 110 is adapted to perform the main functions of the multimedia content output apparatus 100. Through an input interface 400, the control circuit 110 receives the image signal, audio signal and the content-classification identifying message, and then transforms the image signal as a display driving signal, transforms the audio signal as an audio driving signal, and compares with the content-classification identifying message.

The image capturing element 120 electrically connects with the control circuit 110 to capture at least one audience image and transmit to the control circuit 110.

The age identifying module 130 electrically connects with control circuit 110 to receive the audience image. Moreover, the age identifying module 130 connects with a feature database 152; the feature database 152 stores plural age features. These age features includes various face features, body shapes, wrinkles and hair colors of various audiences; each of the age features is assigned with an age weight value.

The age identifying module 130 analyze the audience image, divides the audience image into plural feature portions according to the audience's body shape, face and hair portions. Next, the age identifying module 130 compare each of the feature portions with different age features, and then find out the age feature that match each of the feature portions. Afterwards, the age identifying module 130 sums up the age weight values of the matched age features to obtain an age identification value that corresponds to the audience. The aforesaid methods mentioned to identify the age identification value of the audience is only for explanatory purpose, and should not be limited to the disclosed methods. For those who are skilled in the art with ordinary knowledge should be able to choose any appropriate method from the conventional image/face identification technologies to realize the present invention.

As shown in FIG. 1, the control circuit 110 is also adapted to load a program classification table 151.

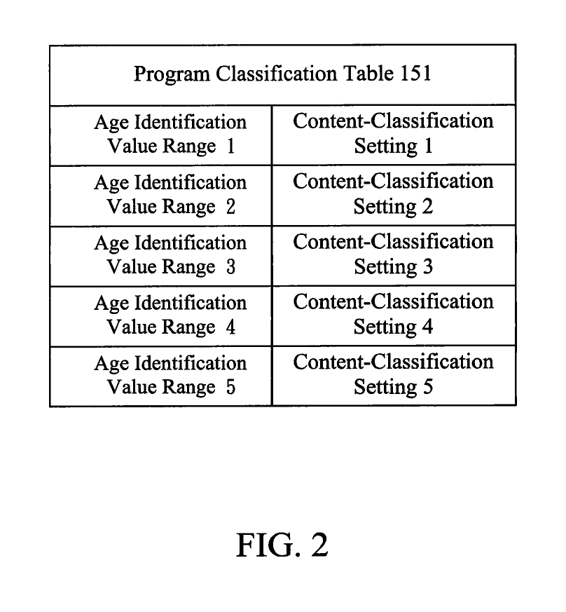

As shown in FIG. 2, the program classification table 151 records plural ranges of the age identification value, and content-classification settings corresponding to each of the ranges of the age identification value. The control circuit 110 uses the obtained age identification value to compare with the preset age identification value ranges, so as to obtain the corresponding content-classification setting from the program classification table 151.

As shown in FIG. 2, the program classification table 151 mentioned above includes plural content-classification settings. Each of the content-classification settings respectively includes one or more preset content-classification code. According to the current U.S. TV program classifications, the content-classification identifying message or the preset content-classification code includes: TV-Y, suitable for children of ages 2-6 yet suitable for all age ranges of audiences, namely all audiences may watch the TV-Y class contents; TV-Y7, suitable for elder children over 7; TV-G, corresponding to all age ranges of audiences; TV-PG, for children under 14, requiring parents guardian; TV-14, not suitable for ages under 14; TV-MA, adults only. The program classifications mentioned above are for explanatory purpose, and should not be limited to the disclosed classifications. For those who are skilled in the art with ordinary knowledge should be able to choose any appropriate method from the conventional age identification technologies to realize the present invention. There are also other program classifications. For example, MPAA (Motion Picture Association of America) has filtrating setting aimed to movie films, including the following classifications: G (GENERAL AUDIENCES; All ages admitted), PG(PARENTAL GUIDANCE SUGGESTED; Some material may not be suitable for children), PG13(PARENTS STRONGLY CAUTIONED; Some material may be inappropriate for children under 13), R(RESTRICTED Under 17; requires accompanying parent or adult guardian), NC-17(NO ONE 17 AND UNDER ADMITTED) or X(RESTRICTED; adults only).

As mentioned above, each of the content-classification settings corresponding to the age identification value is not limited to a content-classification identifying message. Take the current U.S. TV program classifications as an example, an audience aged above 18 can actually unlimitedly watch all programs of all classifications (TV-Y, TV-Y7, TV-G, TV-PG, TV-14, and TV-MA). Assuming that in FIG. 2, the age identification value range 1 is above age 18, then the corresponding content-classification setting 1 should be able to include all the preset content-classification codes corresponding to all the programs of all classifications (TV-Y, TV-Y7, TV-G, TV-PG, TV-14, and TV-MA).

Refer to FIG. 1. The control circuit 110 determine whether the content-classification identifying message(s) carried by the multimedia content signal matches with any preset content-classification code corresponding to the age identification value range; if the content-classification identifying message matches with any preset content-classification code, the control circuit 110 transforms the image signal as the display driving signal, and transmits to the display chip 140 and outputs to the display unit 200 to display images on the display unit 200. If the content-classification identifying message of the multimedia content signal does not match with the preset content-classification code corresponding to the age identification value range, the control circuit 110 does not output the display driving signal, so that the display unit 200 does not display images.

Furthermore, the multimedia content signal does not only include image signals; the multimedia content signal may also be transmitted with accompanying audio signals. As shown in FIG. 1, the control circuit 110 receives the audio signal through the input interface 400 together with the image signal, and then selectively transforms the audio signal as the audio driving signal.

Refer to FIG. 1. The control circuit 110 compares the preset content-classification codes of the content-classification settings to determine whether it matches with the content-classification identifying message within the multimedia content signal. If the content-classification identifying message matches with any preset content-classification code, the control circuit 110 transforms the audio signal as the audio driving signal, and then transmits to audio chip 150 and the audio unit 300 for outputting audio effects from the audio unit 300. If the content-classification identifying message of the multimedia content signal does not match with the preset content-classification code corresponding to the age identification value range, the control circuit 110 does not output the audio driving signal so that the audio unit 300 does not output any audio effect.

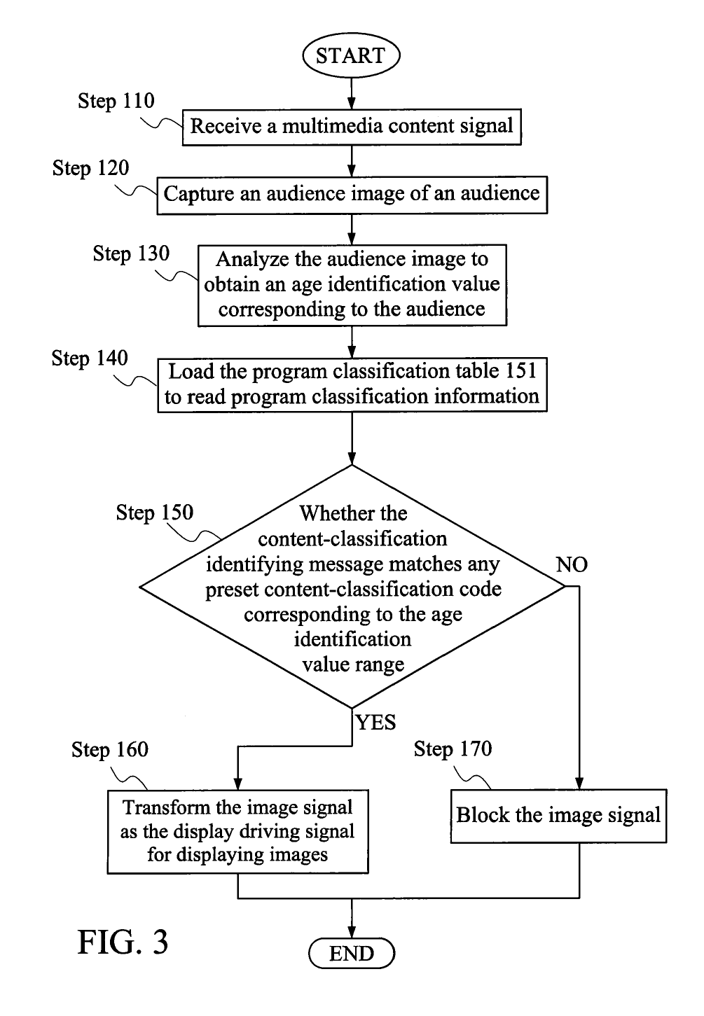

As shown in FIG. 1 to FIG. 3, the first embodiment according to the present invention further discloses a multimedia content output method for filtrating multimedia content signals according to audience age; the multimedia content output method determines whether to output the display driving signal and the audio driving signal to drive the display unit 200 and the audio unit 300 according to the audience's age and the content-classification identifying message.

According to the method, after the multimedia content output apparatus 100 is booted, through the input interface 400 the control circuit 110 receives a multimedia content signal, as shown in Step 110. The multimedia content signal may at least be decoded as an image signal, an audio signal and a content-classification identifying message.

Next, the control circuit 110 controls the image capturing element 120 to capture an audience image of an audience located in the front of the display unit 200 and ready to watch multimedia contents , as shown in Step 120.

The control circuit 110 transmits the audience image to the age identifying module 130; the age identifying module 130 analyzes the audience image to obtain an age identification value corresponding to the audience, as shown in Step 130.

The control circuit 110 loads the program classification table 151 to read program classification information, as shown in Step 140; the program classification table 151 records plural age identification value ranges and content-classification settings corresponding to each of the age identification value range. Each of the content-classification settings further includes one or more preset content-classification code.

Afterwards, the control circuit 110 determines whether the content-classification identifying message carried by the multimedia content signal matches any preset content-classification code corresponding to the age identification value range, as shown in Step 150.

As shown in Step 160, if the content-classification identifying message matches with any preset content-classification code, the control circuit 110 transforms the image signal as the display driving signal for displaying images on the display unit 200.

As shown in Step 170, if the content-classification identifying message does not match with the preset content-classification code corresponding to the age identification value range, the control circuit 110 blocks the image signal so that the display unit 200 does not display images.

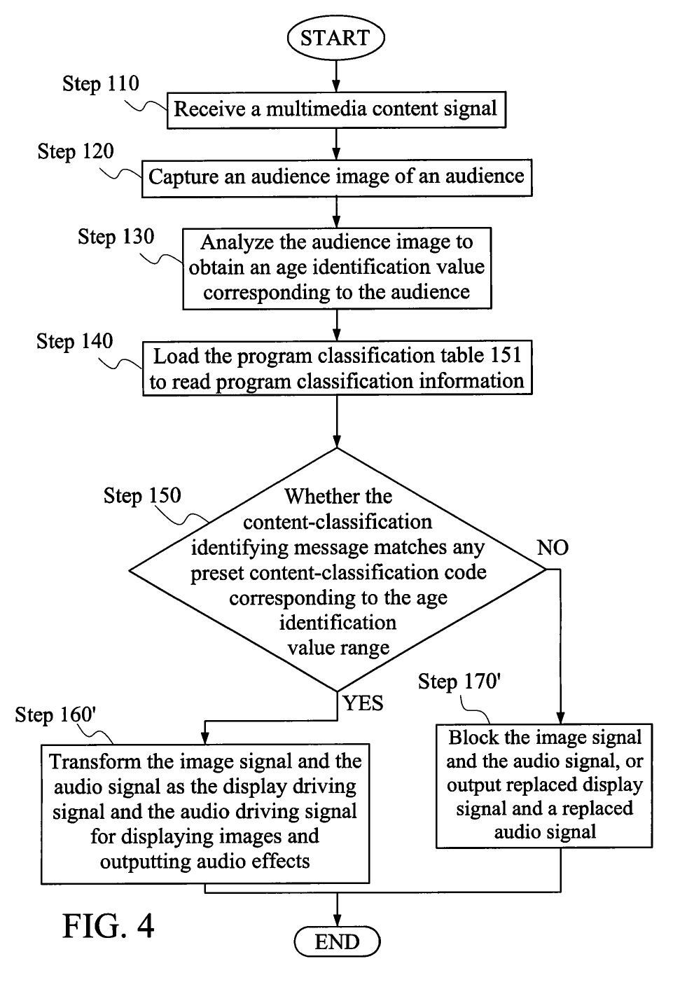

Refer to FIG. 1, FIG. 2 and FIG. 4. The multimedia content signal mentioned above does not include image signals only; the multimedia content signal also includes audio signals. Since usually an audio content is transmitted and output together with the image content, the audio content should be blocked as well when the image content is blocked. Therefore, Step 160 and Step 170 should be amended as Step 160′ and Step 170′, so as to output or block the audio content.

As shown in Step 160′, if the control circuit 110 determines that the content-classification identifying message carried by the multimedia content signal matches with any preset content-classification code corresponding to the age identification value range, the control circuit 110 transforms the image signal as the display driving signal for displaying images on the display unit 200. Meanwhile the control circuit 110 transforms the audio signal as the audio driving signal to output audio effects on the audio unit 300.

As shown in Step 170′, if the content-classification identifying message does not match with the preset content-classification code corresponding to the age identification value range, the control circuit 110 blocks the image signal and the audio signal, so that the display unit 200 does not show images and the audio unit 300 does not output any audio effects.

In Step 170′, about the way to block the image signal and the audio signal, aside from blocking the outputs of the display driving signal and the audio driving signal, a replaced display signal and a replaced audio signal may be output to display a replaced image on the display unit 200 and output replaced audio effects on the audio unit 300.

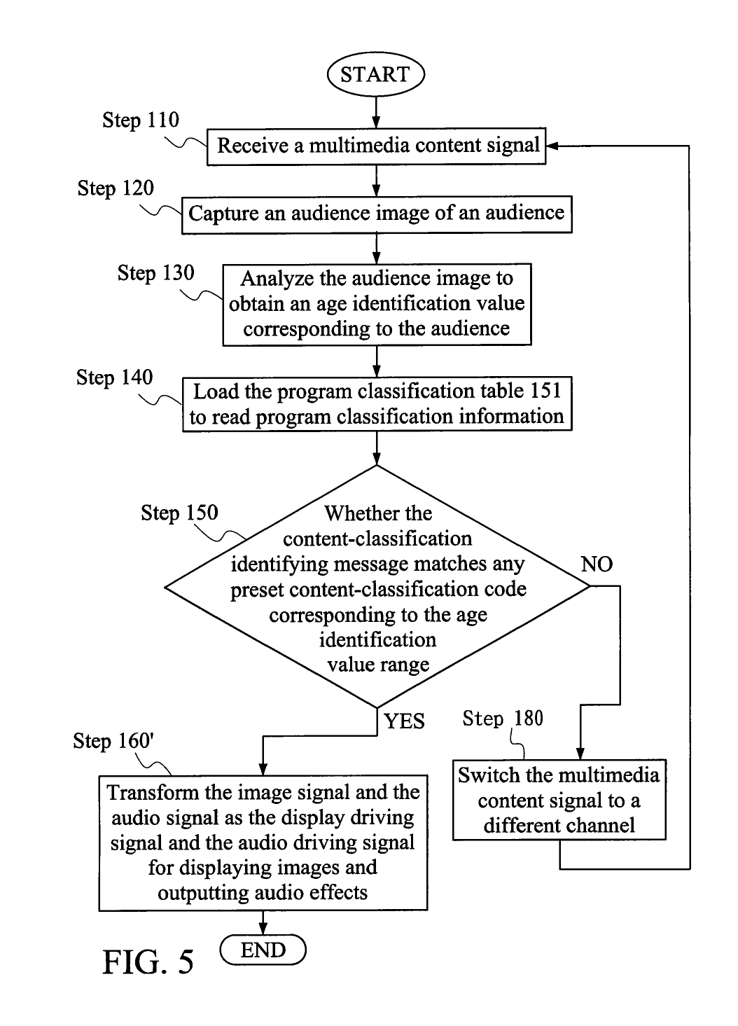

Refer to FIG. 5. Aside from blocking the image signal and the audio signal, Step 170′ may be replaced by Step 180. If the control circuit 110 determines that the content-classification identifying message does not matches with the preset content-classification code of the age identification value, the control circuit 110 switches the multimedia content signal to a different channel and re-performs Step 110, so that the audience may be able to find appropriate multimedia contents suitable for his/her age.

According to the present invention, the audience image is analyzed to identify the audience age and then filtrates the multimedia content signal; such approach simplifies the process of filtrating the multimedia content signal and also avoids the conventional problems of password input and password leakage.

The aforesaid first embodiment according to the present invention mainly bases on a single audience to filtrate the multimedia content signals according to the only audience's age. However, in real applications, there are usually multiple audiences present in front of the display unit 200, watching the same multimedia contents.

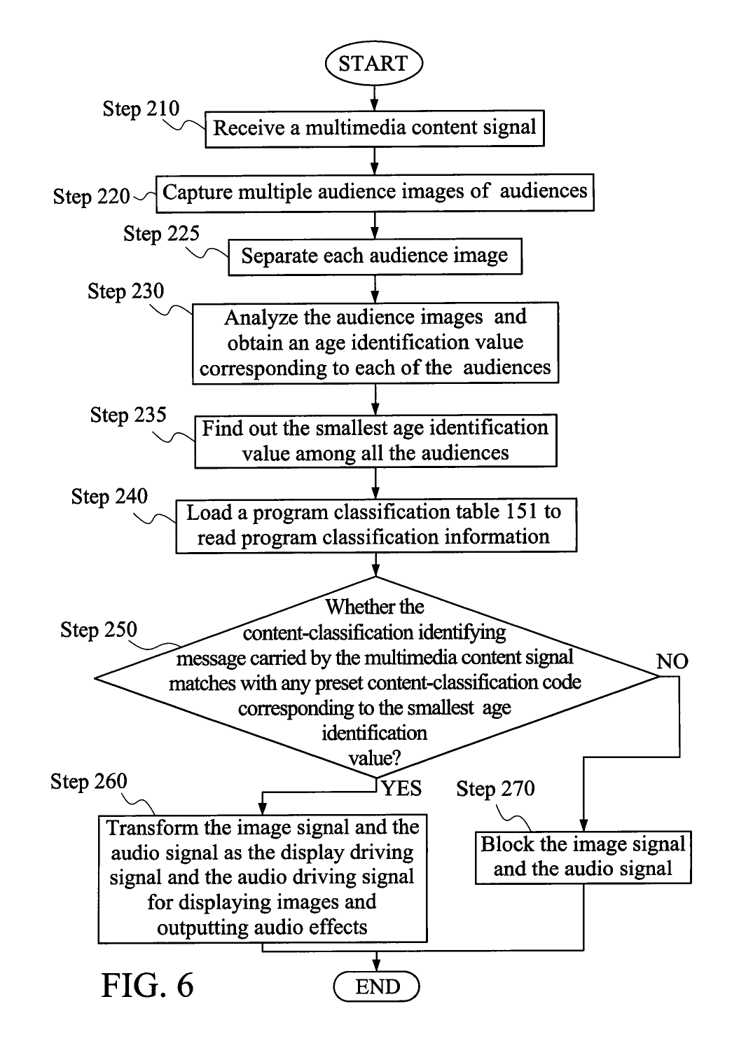

Refer to FIG. 1, FIG. 2 and FIG. 6. FIG. 6 shows a flow chart of a multimedia content output method according to a second embodiment of the present invention.

According to the method of the present invention, after the multimedia content output apparatus 100 is booted, the control circuit 110 receives a multimedia content signal through the input interface 400, as shown in Step 210.

Next, the control circuit 110 controls the image capturing element 120 to capture multiple audience images of the audiences present in front of the display unit 200 and ready for watching multimedia contents, as shown in Step 220.

Since the age of each of the audiences needs to be identified respectively, the control circuit 110 separates each audience image to respectively identify the age of each of the audiences, as shown in Step 225.

Afterwards, the age identifying module 130 analyzes each of the audience images, and obtains an age identification value corresponding to each of the audience images for the audiences, as shown in Step 230.

According to the identification results of the age identifying module 130, the control circuit 110 finds out the smallest age identification value among all the audiences, as shown in Step 235. Then, the control circuit 110 loads a program classification table 151 to read program classification information, as shown in Step 240.

Next, the control circuit 110 determines whether the content-classification identifying message carried by the multimedia content signal matches with any preset content-classification code corresponding to the smallest age identification value, as shown in Step 250.

As shown in Step 260, if the control circuit 110 determines that the content-classification identifying message carried by the multimedia content signal matches with any preset content-classification code of the smallest age identification value, the control circuit 110 transforms the image signal as the display driving signal, and transmits through the display chip 140 to the display unit 200 for displaying images on the display unit 200. In the meantime the control circuit 110 transforms the audio signal as the audio driving signal, and transmits through the audio chip 150 to the audio unit 300 to output audio effects on the audio unit 300.

As shown in Step 270, if the control circuit 110 determines that the content-classification identifying message does not match with any preset content-classification code corresponding to the smallest age identification value, the control circuit 110 blocks the image signal and the audio signal so that the display unit 200 does not display images and the audio unit 300 does not output audio effects.

The above-mentioned method of using the smallest age identification value as the base to filtrate the multimedia content signal may effectively avoid deactivating the filtrating function inadequately when an adult is present in front of the display unit 200.

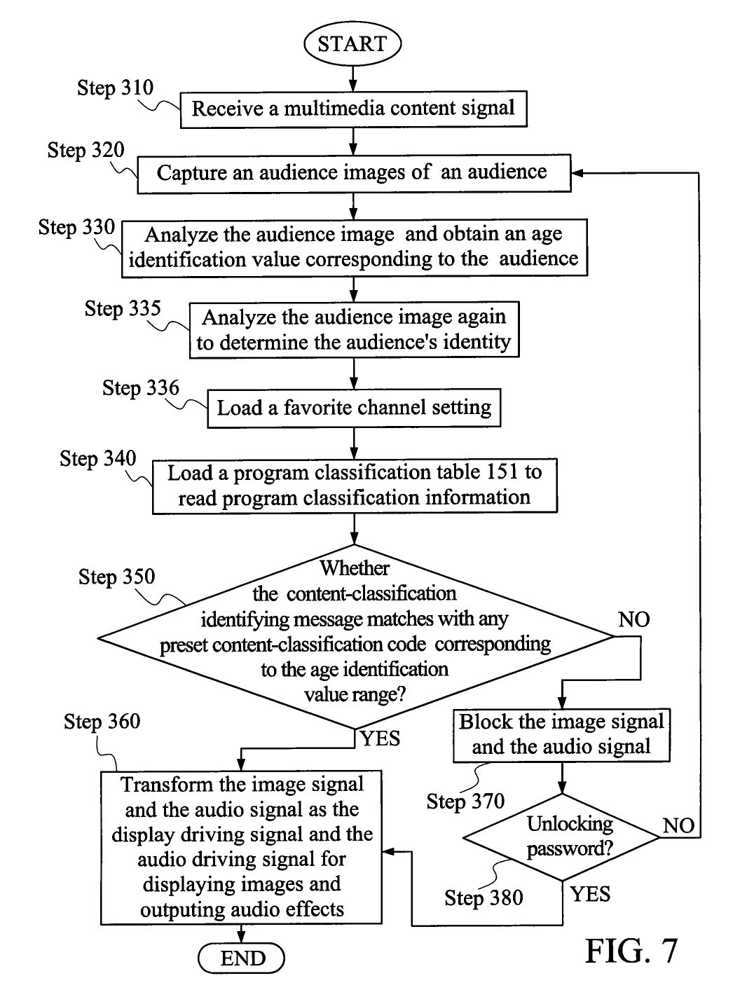

Refer to FIG. 1, FIG. 2 and FIG. 7; FIG. 7 shows a flow chart of a multimedia content output method according to a third embodiment of the present invention.

The multimedia content signal includes multiple channels; in each of the channels, the multimedia content signal may be respectively decoded as an image signal, an audio signal and a content-classification identifying message. The multimedia content output method is able to set switchable channels according to the audience's interests, and determine whether to output the display driving signal and the audio driving signal to drive the display unit 200 and the audio unit 300 according to the age(s) of the audience(s) and the content-classification identifying message(s).

According to the method, after the multimedia content output apparatus 100 is booted, the control circuit 110 first receives a multimedia content signal through an input interface 400, as shown in Step 310.

Next, the control circuit 110 controls the image capturing element 120 to capture the audience image of the audience present in front of the display unit 200 and ready for watching the multimedia contents, as shown in Step 320.

The control circuit 110 transmits the audience image to the age identifying module 130, for analyzing the audience image and obtaining an age identification value corresponding to the audience, as shown in Step 330.

Then, the age identifying module 130 analyzes the audience image again to determine the audience's identity, as shown in Step 335.

According to the audience's identity, the control circuit 110 loads a favorite channel setting, as shown in Step 336; the favorite channel setting records multiple specific channels set by the audience. According to the favorite channel setting, the control circuit 110 may only switch between the preset specific channels, without switching to any channel out of the specific channels.

Although in Step 336, the control circuit 110 is set to select the specific channels according to the audience's identity, the classifications of the transmitted multimedia contents may somehow not match the audience's age due to the changes of the multimedia contents transmitted within the specific channels. Therefore, after the specific channels have been selected, the control circuits 110 still needs to filtrates the multimedia content signal according to the audience's age. One approach is that the control circuit 110 loads a program classification table 151 to read program classification information, as shown in Step 340.

Afterwards, the control circuit 110 determines whether the content-classification identifying message carried by the multimedia content signal matches with any preset content-classification code corresponding to the age identification value range, as shown in Step 350. If the content-classification identifying message matches with any preset content-classification code, the control circuit 110 performs Step 360 to display images and output audio effects; if does not match, the control circuit 110 performs Step 370, display no image and output no audio effects, or displaying replaced images and outputting replaced audio effects.

If the age identification value is obviously lower than the actual age of the audience, for instance the audience's identity being recorded as an adult yet the age identification value corresponding to a person under age and causing the audience not able to watch multimedia contents of the specific channels set in the favorite channel setting, as shown in Step 370, the audience may now input an unblocking password. The unblocking password may be preset in the control circuit 110, so that the control circuit 110 does not block the image signal and the audio signal. The control circuit 110 determines whether the input unblocking password is the same as the stored unblocking password in the control circuit 110, as shown in Step 380. If the input unblocking password is correct, the control circuit 110 stops blocking the image signal and the audio signal, and then performs Step 360. If the input unblocking password is wrong or the audience does not input the unblocking password, the control circuit 110 re-performs Step 320, so as to re-capture the audience image, re-obtain the age identification value and the audience's identity.

According to the present invention, the audience age is identified from the audience image, and then used as a base to filtrate the multimedia contents. The input of unblocking password is only a redundant function, so the password leakage problem may be prevented. Meanwhile, with multiple audiences' presence, the filtrating function according to the present invention is reset to filtrate according to the youngest audience's age so as to prevent from failing to set the filtrating function for the presence of both an adult and a young audience. In the meantime, the identification of the audience image may also be applied to identify the audience's identity and use for setting the favorite specific channels, thereby helping the audience to switch between the favorite specific channels.

While the present invention has been described by the way of example and in terms of the preferred embodiments, it is to be understood that the invention need not to be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A multimedia content output apparatus for filtrating a multimedia content signal according to an audience's age, comprising:
an image capturing element, capturing at least one audience image of the audience;
an age identifying module, receiving and analyzing the audience image to obtain an age identification value of the audience; and
a control circuit, receiving an image signal and a content-classification identifying message, and transforming the image signal as a display driving signal, the control circuit loading a program classification table with a plurality of age identification value ranges and at least one preset content-classification code corresponding to each of the age identification value ranges;
wherein the control circuit determines whether the content-classification identifying message carried by the multimedia content signal matches with any of the preset content-classification codes corresponding to the age identification value range; if the content-classification identifying message matching with any of the preset content-classification codes, the control circuit transforming the image signal as the display driving signal and outputting.

2. The multimedia content output apparatus as claimed in claim 1, wherein the control circuit also receives an audio signal, the control circuit transforming the audio signal as an audio driving signal and outputting if the content-classification identifying message matches with any of the preset content-classification codes.

3. The multimedia content output apparatus as claimed in claim 1, wherein:
the age identifying module connects with a feature database, the feature database store a plurality of age features, each of the age features being assigned with an age weight value; and
the age identifying module divides the audience image into a plurality of feature portions, each of the feature portions being compared with different ones of the age features to find out the age features that match with the feature portions, the age weight value of each of the matched age features being summed up to obtain the age identification value.

4. A multimedia content output method for filtrating a multimedia content signal according to an audience's age, comprising:
receiving a multimedia content signal, wherein the multimedia content signal is decoded into an image signal and a content-classification identifying message;
capturing at least an audience image of the audience;
analyzing the audience image to obtain an age identification value corresponding to the audience's age;
loading a program classification table, the program classification table recording a plurality of age identification value ranges and at least one preset content-classification code corresponding to each of the age identification value ranges;
determining whether the content-classification identifying message matches with any of the preset content-classification codes corresponding to the age identification value range; and
transforming the image signal as a display driving signal and outputting if the content-classification identifying message matches with any of the preset content-classification codes.

5. The multimedia content output method as claimed in claim 4 further comprising:
outputting a replaced display signal if the content-classification identifying message does not match with any of the preset content-classification codes corresponding to the age identification value range.

6. The multimedia content output method as claimed in claim 4, wherein
the multimedia content signal is further decoded into an audio signal, and outputting a replaced audio signal if the content-classification identifying message does not match with any of the preset content-classification codes corresponding to the age identification value range.

7. The multimedia content output method as claimed in claim 4 further comprising:
switching channels in the multimedia content signal if the content-classification identifying message does not match with any of the preset content-classification code corresponding to the age identification value.

8. The multimedia content output method as claimed in claim 4 further comprising:
identifying the audience's identity, loading a favorite channel setting according to the audience's identity with the favorite channel setting recording a plurality of specific channels, and switching between the specific channels according to the favorite channel setting.

9. The multimedia content output method as claimed in claim 4, wherein if the content-classification identifying message does not match with any of preset content-classification codes corresponding to the age identification value range, the method further comprising:
determining whether an input unblocking password is correct; and
transforming the image signal as a display driving signal and outputting if the input unblocking password is correct.

10. The multimedia content output method as claimed in claim 4, wherein the step of obtaining the age identification value further comprising:
dividing the audience image into a plurality feature portions;
comparing each of the feature portions with a plurality of different age features, to find out the age features matched with each of the feature portions, wherein each of the age features is assigned with an age weight value; and
summing up the age weight value of each of the matched age features to obtain that age identification value.

11. A multimedia content output method for filtrating a multimedia content signal according to a plurality of audiences' ages, comprising:
receiving a multimedia content signal, wherein the multimedia content signal is decoded as an image signal and a content-classification identifying message;
capturing a plurality of audience image of the audiences;
analyzing each of the audience images to obtain an age identification value corresponding to each of the audiences' ages;
finding out the smallest age identification value within the audiences;
loading a program classification table, the program classification table recording a plurality of age identification value ranges and at least one preset content-classification code corresponding to each of the age identification value range;
determining if the content-classification identifying message matches with any of the preset content-classification codes corresponding to the smallest age identification value; and
transforming the image signal as a display driving signal and outputting if the content-classification identifying message matches with any of the preset content-classification codes corresponding to the smallest age identification value.

12. The multimedia content output method as claimed in claim 11 further comprising:
outputting a replaced display signal if the content-classification identifying message does not match with any of the preset content-classification codes corresponding to the smallest age identification value.

13. The multimedia content output method as claimed in claim 11, wherein the multimedia content signal is further decoded into an audio signal, the method further comprising:
outputting a replaced audio signal if the content-classification identifying message does not match with any of the preset content-classification codes corresponding to the smallest age identification value.

14. The multimedia content output method as claimed in claim 11 further comprising:
switching channels in the multimedia content signal if the content-classification identifying message does not match with any of the preset content-classification code corresponding to the smallest age identification value.

15. The multimedia content output method as claimed in claim 11 further comprising:
identifying the audience's identity with the smallest age identification value, loading a favorite channel setting according to the audience's identity with the favorite channel setting recording a plurality of specific channels, and switching between the specific channels according to the favorite channel setting.

16. The multimedia content output method as claimed in claim 11, wherein if the content-classification identifying message does not match with any of preset content-classification codes corresponding to the smallest age identification value range, the method further comprising:
determining whether an input unblocking password is correct; and
transforming the image signal as a display driving signal and outputting if the input unblocking password is correct.

17. The multimedia content output method as claimed in claim 11, wherein the step of obtaining the age identification value further comprising:
dividing the audience image into a plurality feature portions;
comparing each of the feature portions with a plurality of different age features, to find out the age features matched with each of the feature portions, wherein each of the age features is assigned with an age weight value; and
summing up the age weight value of each of the matched age features to obtain that age identification value.
